(19) United States
(12) Patent Application Publication
(10) Pub. No.: US 2020/0074559 A1
(43) Pub. Date: Mar. 5, 2020

(54) SYSTEM AND A METHOD FOR COMPUTING INFRASTRUCTURAL DAMAGES

(71) Applicant: Cognizant Technology Solutions India Pvt. Ltd., Chennai (IN)

(72) Inventors: Venkatesh Srinivasan, Chennai (IN); Abhishek Mishra, Bengaluru (IN); Madhusudhanan Krishnamoorthy, Chennai (IN); Kumar Ganapathy, Chennai (IN)

(21) Appl. No.: 16/188,681

(22) Filed: Nov. 13, 2018

(30) Foreign Application Priority Data
Sep. 3, 2018 (IN) 201841033000

(51) Int. Cl. G06Q 40/08; G06K 9/00; G06F 17/30; G01W 1/10

(52) U.S. Cl. CPC G06Q 40/08; G06K 9/00637; G06K 2009/00644; G01W 1/10; G06F 17/30241

(57) ABSTRACT

A system and a method for computing infrastructural damages is disclosed. In particular, the present invention provides for identifying one or more potential areas to be impacted during a predicted calamity and classifying the one or more potential areas based on severity of impact in said areas. Further, a first group of datasets associated with one or more potential areas are generated. A pre-calamity data is generated based on the first group of datasets using one or more processing techniques. Further, the present invention provides for generating a post-calamity data based on a second group of datasets associated with respective one or more geographical areas actually affected by the predicted calamity. The damage associated with each of the said properties is computed based on at least one of a comparison between the pre-calamity and the post-calamity data, or based on the post-calamity data.

### FIELD OF THE INVENTION

The present invention relates generally to the field of data processing and analytics. More particularly, the present invention relates to a system and a method for computing infrastructural damages caused by calamities.

### BACKGROUND OF THE INVENTION

Calamities, such as earthquakes, floods, storms, hurricanes, tornadoes and fire, may cause significant damage to life and infrastructure. Estimating the extent of damage caused by such calamities may assist various industries to prioritize their services for effective disaster management and control. For instance, after a calamity the volume of insurance claims associated with infrastructural damage increases significantly for insurance companies. Sudden increase in claim volume makes the management process tedious and time consuming due to inaccessibility to damaged properties and inability of the insurance company to accurately estimate total potential damages. This results in erroneous or delayed claim dispersal, further resulting in unwarranted disputes.

In light of the above drawbacks, there is a need for a system and a method for accurately estimating infrastructural damages caused by a calamity. There is a need for a system and a method which can remotely detect infrastructural damages associated with each property individually. There is a need for a system and a method which eliminates the need for a person to physically access the infrastructural damages associated with each property. Furthermore, there is a need for a system and a method which is inexpensive, fast and reliable. Yet further, there is a need for a system and a method which can be easily deployed and maintained.

### SUMMARY OF THE INVENTION

A method for computing infrastructural damages caused by a calamity is provided. In various embodiments of the present invention, the method is implemented by at least one processor executing program instructions stored in a memory. The method comprises generating, by the processor, a first group of datasets associated with one or more potential areas. The one or more potential areas are representative of one or more geographical areas identified to be impacted by a predicted calamity. The method further comprises generating, by the processor, a pre-calamity data based on the first group of datasets. Furthermore, the method comprises generating, by the processor, a second group of datasets associated with one or more impacted areas. The one or more impacted areas are representative of one or more geographical areas impacted by the predicted calamity. Yet further, the method comprises generating, by the processor, a post calamity data based on the second group of datasets. Finally, the method comprises computing, by the processor, damages associated with one or more predetermined properties in each of the one or more impacted areas based on at least one of the post calamity data, and a comparison between the pre-calamity data and the post calamity data.

A system for computing infrastructural damages caused by a calamity is provided. In various embodiments of the present invention, the system interfaces with a weather subsystem, an insurance database and one or more image servers. The system comprises a memory storing program instructions, a processor configured to execute program instructions stored in the memory, and a damage computation engine in communication with the processor. Further, the system is configured to generate a first group of datasets associated with one or more potential areas, wherein the one or more potential areas are representative of one or more geographical areas identified to be impacted by a predicted calamity. Furthermore, the system is configured to generate a pre-calamity data based on the first group of datasets. The system is configured to generate a second group of datasets associated with one or more impacted areas. The one or more impacted areas are representative of one or more geographical areas impacted by the predicted calamity. Yet further, the system is configured to generate a post calamity data based on the second group of datasets. Finally, the system computes damages associated with one or more predetermined properties in each of the one or more impacted areas based on at least one of the post calamity data, and a comparison between the pre-calamity data and the post calamity data.

A computer program product is provided. The computer program product comprises a non-transitory computer-readable medium having computer-readable program code stored thereon, the computer-readable program code comprising instructions that, when executed by a processor, cause the processor to generate a first group of datasets associated with one or more potential areas. The one or more potential areas are representative of one or more geographical areas identified to be impacted by a predicted calamity. Further, a pre-calamity data is generated based on the first group of datasets. Furthermore, a second group of datasets associated with one or more impacted areas is generated. The one or more impacted areas are representative of one or more geographical areas impacted by the predicted calamity. Yet further, a post calamity data based on the second group of datasets is generated. Finally, damages associated with one or more predetermined properties in each of the one or more impacted areas are computed based on at least one of the post calamity data, and a comparison between the pre-calamity data and the post calamity data.

### BRIEF DESCRIPTION OF THE ACCOMPANYING DRAWINGS

The present invention is described by way of embodiments illustrated in the accompanying drawings wherein:

FIG. 1 illustrates a block diagram of a system for computing infrastructural damages caused by a calamity, in accordance with an embodiment of the present invention;

FIG. 2 illustrates a detailed block diagram of a damage computation subsystem for computing infrastructural damages caused by a calamity, in accordance with an embodiment of the present invention;

FIG. 3 is a flowchart illustrating a method for computing infrastructural damages caused by a calamity, in accordance with an embodiment of the present invention;and

FIG. 4 illustrates an exemplary computer system in which various embodiments of the present invention may be implemented.

### DETAILED DESCRIPTION OF THE INVENTION

The present invention discloses a system and a method for computing infrastructural damages caused by a calamity. In particular, the system and method of the present invention provides for identifying one or more potential areas to be impacted during a predicted calamity and classifying the one or more potential areas based on severity of impact in said areas. Further, a first group of datasets associated with one or more potential areas are generated. The first group of datasets may include, but is not limited to boundary vertices associated with one or more potential areas respectively, and insurance data associated with one or more predetermined properties within corresponding potential area. A pre-calamity data is generated based on the first group of datasets using one or more processing techniques. The pre-calamity data includes, but is not limited to a property view of each of the predetermined properties, one or more attributes associated with each of the predetermined properties and damage risk associated with each of the said properties. Further, the present invention provides for generating a post-calamity data based on a second group of datasets associated with respective one or more geographical areas actually affected by the predicted calamity. The post-calamity data includes a property view of each of the predetermined properties and one or more attributes associated with each of the predetermined properties. The damage associated with each of the said properties is computed based on at least one of a comparison between the pre-calamity and the post-calamity data, or based on the post-calamity data. Furthermore, the system and method of the present invention, provides for quantifying repair cost associated with each of the predetermined properties based on the estimated damages.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

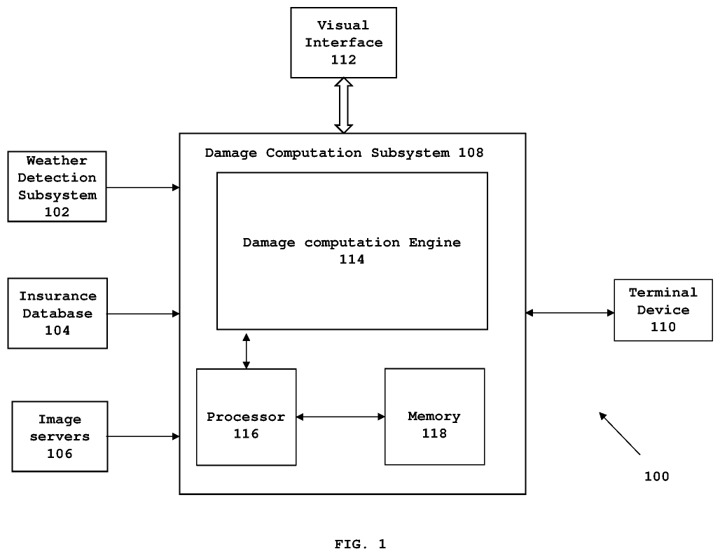

FIG. 1 illustrates a block diagram of a system for computing infrastructural damages during or after a calamity, in accordance with an embodiment of the present invention.

Referring to FIG. 1, in an embodiment of the present invention, the system 100 comprises a weather detection subsystem 102, an insurance database 104, one or more image servers 106, a damage computation subsystem 108 and a terminal device 110.

In an embodiment of the present invention, the weather detection subsystem 102 may include any wired or wireless processing device capable of executing instructions. The weather detection subsystem 102 is configured to predict weather conditions and calamities such as earthquakes, floods, storms, hurricanes, tornadoes etc. in one or more geographical area. In another embodiment of the present invention, the weather detection subsystem 102 may be a software module executed in a computing device in a remote location. In an embodiment of the present invention, as shown in FIG. 1, the weather detection subsystem 102 interfaces with the damage computation subsystem 108 over a communication network (not shown). The weather detection subsystem 102 is configured to provide weather and calamity prediction data to the damage computation subsystem 108 in response to a query generated by said subsystem 108.

In various embodiments of the present invention, the insurance database 104 is a database of one or more properties located in various geographical areas. In an exemplary embodiment of the present invention, the insurance database 104 may be maintained in a storage remote to the damage computation subsystem 108. In an exemplary embodiment of the present invention, as shown in FIG. 1, the insurance database 104 is configured to maintain insurance data associated one or more properties, located in one or more geographical areas. The insurance data may include, but is not limited to property information, coverage details and building attributes. Examples of property information may include, but are not limited to construction time, residence type, occupancy, nearby emergency services. In an embodiment of the present invention, building attributes may include, but are not limited to address, area information, number of rooms, material characteristics and number of floors.

In an embodiment of the present invention, the one or more image servers 106 are configured to collect aerial images of one or more geographical areas via satellite imagery, manned aerial vehicles or unmanned aerial vehicles or any other image source. The aerial images may include, but are not limited to panchromatic, multi spectral, near infrared, LIDAR, tiff and geotiff images. The image servers 106 maintains a database of collected images based on a set of variables including, but not limited to location, boundary and other geographic parameters. Further, the one or more image servers 106 interfaces with the damage computation subsystem 108 to provide imagery services in response to a request received from said damage computation subsystem 108.

In various exemplary embodiments of the present invention, the terminal device 110 may include but is not limited to a smart phone, a computer, a tablet, microcomputer or any other wired or wireless processing device. In an embodiment of the present invention, the terminal device 110 may be configured to interact with the damage computation subsystem 108 to receive results of computation performed by the damage computation subsystem 110.

In an exemplary embodiment of the present invention, as shown in FIG. 1, the damage computation subsystem 108 interfaces with the weather detection subsystem 102, the insurance database 104, the one or more image servers 106 over a first communication channel (not shown). Further, the damage computation subsystem 108 interfaces with the terminal device 110 over a second communication channel (not shown). In an embodiment of the present invention, the examples of the first and the second communication channel may include a physical transmission medium, such as, a wire, or a logical connection over a multiplexed medium, such as, a radio channel in telecommunications and computer networking. The examples of radio channel in telecommunications and computer networking may include a Local Area Network (LAN), a Metropolitan Area Network (MAN), and a Wide Area Network (WAN).

The damage computation subsystem 108 comprises a visual interface 112, a damage computation engine 114, a processor 116 and a memory 118. In various embodiments of the present invention, the visual interface 112 is a graphical user interface which allows user interaction with the damage computation engine 114. In an exemplary embodiment of the present invention, the visual interface 112 is configured with graphical icons to select one or more properties and their associated data, and view one or more processing and computation results generated by the damage computation engine 114.

In various embodiments of the present invention, the damage computation engine 114 is a self-learning engine configured to monitor weather and calamity prediction data, classify one or more geographical areas to be impacted by one or more predicted calamities based on severity of impact and generate pre-calamity data associated with one or more properties in the one or more geographical areas using one or more processing techniques. Further, the damage computation engine 114 is configured to generate a post-calamity data and compute damages associated with one or more properties.

In particular, the damage computation engine 114 is configured to monitor weather conditions and calamity predictions via the weather detection subsystem 102. The damage computation engine 114 retrieves weather and calamity prediction data associated with one or more geographical areas. The damage computation engine 114 identifies one or more geographical areas to be impacted during a predicted calamity based on the weather and calamity prediction data retrieved from the weather detection subsystem 102 using one or more processing techniques. The geographical areas which may be impacted by the predicted calamity are hereinafter referred to as potential areas. The damage computation engine 114 further determines area codes associated with corresponding one or more potential areas using the one or more processing techniques. In an exemplary embodiment of the present invention, the one or more processing technique may be a geospatial intelligence technique. Further, the damage computation engine 114 classifies the one or more potential areas based on severity of impact in said areas using one or more risk classification techniques. The damage computation engine 114 creates a map view of the one or more potential areas based on the severity of predicted impact. The created map view is displayed via the visual interface 112. The damage computation engine 114, thereafter evaluates the date and time for initiating the generation of the pre-calamity data based on the retrieved calamity prediction data and severity of impact.

In an embodiment of the present invention, the damage computation engine 114 determines the boundary vertices of the one or more potential areas in the order of severity of impact based on the determined area codes using one or more deep learning techniques. Further, the damage computation engine 114 is configured to retrieve insurance data associated with one or more predetermined properties in one or more potential areas, respectively from the insurance database 104. As already described above, the insurance data may include, but is not limited to property information, coverage details and building attributes. Examples of property information may include, but are not limited to construction time, residence type, occupancy, nearby emergency services. In an embodiment of the present invention, building attributes may include, but are not limited to address, area information, number of rooms, material characteristics and number of floors. In an embodiment of the present invention, the damage computation engine 114 may initiate retrieval of insurance data based on a selection of one or more predetermined properties in the said one or more areas. The one or more properties may be selected via the visual interface 112.

In an embodiment of the present invention, the damage computation engine 114 generates a first group of datasets associated with one or more potential areas, respectively, by processing evaluated date and time, the determined boundary vertices and the retrieved insurance data using a first set of rules. In an exemplary embodiment of the present invention, the first set of rules comprises mapping the insurance data associated with one or more properties in each potential areas with the boundary vertices of the corresponding potential area using geospatial intelligence techniques. Further, the first set of rules comprises combining the mapped data with date and time for initiating the generation of the pre-calamity data.

In an embodiment of the present invention, the damage computation engine 114 generates a pre-calamity data associated with one or more potential areas based on the generated dataset using one or more processing techniques. The pre-calamity data includes a property view of each of the predetermined properties, one or more attributes associated with each of the predetermined properties and damage risk associated with each of the said properties. In particular, the damage computation engine 114, retrieves images associated with one or more potential areas based on a corresponding dataset from the first group of datasets from the one or more image servers 106. The damage computation engine 114 is configured to analyze the retrieved images based on a set of parameters such as clarity, image format, ground sampling distance, cloud cover, image latency etc. and determine if the image is suitable for further processing.

The damage computation engine 114 rejects the images, if the retrieved images do not meet predefined thresholds associated with the set of parameters. In an exemplary embodiment of the present invention, the predefined thresholds associated with the set of parameters are listed below:

For clarity: Image resolution should be 80 cm by 30 cm for high level assessment of damaged area and greater than 10 cm to quantify the extent of damages;

Image format: Ortho-rectified Geotiff images and metadata files in JSON format;

Ground Sampling Distance (GSD): GSD for satellite images must be 0.3 to 0.8 m for panchromatic, 1-2 m for multispectral; for aircraft imagery GSD should be less than 0.1 m;

Cloud Cover : Cloud cover should be less than 20% for satellite imagery and less than 10% for aircraft imagery;

Image latency: image latency should be less than 48 hours.

Further, new images are retrieved until the images meet the predefined thresholds. The damage computation engine 114 further processes the retrieved images using one or more image processing techniques, if the retrieved images meet the predefined thresholds associated with the set of parameters. In an embodiment of the present invention the image processing techniques is pixel wise segmentation technique. In an exemplary embodiment of the present invention, each satellite image is processed to generate a corresponding image tile by using image processing techniques such as image ingestion, cloud masking, pan sharpening and tilt splitting.

The damage computation engine 114 extracts geo-coordinates of the predetermined one or more properties from the processed images associated with corresponding one or more potential areas using one or more address standardization techniques and geocoding techniques. Further, the damage computation engine 114 identifies a boundary associated with each of the predetermined properties, respectively based on the extracted geo-coordinates using one or more image processing techniques. The damage computation 114 maps the boundary associated with each of the properties with the insurance data embedded in the corresponding first group of datasets to create one or more property views. Each property view is representative of a predetermined property in the corresponding potential area. In an embodiment of the present invention, the one or more property views are created from one or more images using one or more image processing techniques such as image stitching. In an exemplary embodiment of the present invention, an image processing framework such as open CV is used for image stitching. In an embodiment of the present invention, each property view includes boundary vertices of the corresponding property, one or more images of the corresponding property, insurance data (as described in para 18) associated with corresponding property, other properties surrounding the corresponding property etc.

The damage computation engine 114 is configured to determine one or more roof characteristics associated with each of the predetermined properties by analyzing the corresponding property view. The damage computation engine 114 analyses each property view using a combination of one or more deep learning and image processing techniques to identify one or more roof characteristics associated with a predetermined property. In an embodiment of the present invention, the one or more roof characteristics may include, but are not limited to roof type, roof pitch, roof area, roof components and shingle characteristics.

Further, the damage computation engine 114, is configured to compute a damage risk associated with each of the predetermined properties using a second set of rules. The damage computation engine 114 analyzes one or more property views and associated one or more roof characteristics using the second set of rules. In an exemplary embodiment of the present invention, the second set of rules includes identifying any existing damages or weak construction indicating high loss on occurrence of the predicted calamity by analyzing the property view, more particularly the roof images associated with each of the predetermined properties; determining elements representative of increase in damage exposure, such as trees proximal to the predetermined properties, lack of properties surrounding the predetermined property to reduce wind speed etc., nearby water bodies, by analyzing the surrounding areas of each predetermined property; and analyzing severity of predicted impact in the property location and coverage amount associated with total loss of the property.

In an embodiment of the present invention, the damage computation engine 114, generates a post-calamity data based on a second group of datasets. The post-calamity data includes a property view of each of the predetermined properties and one or more attributes associated with each of the predetermined properties. In particular, the damage computation engine 114 is configured to monitor end of the calamity via the weather detection subsystem 102. The damage computation engine 114 retrieves weather and calamity prediction data associated with one or more impacted areas. The damage computation engine 114 further determines area codes associated with corresponding one or more impacted areas using the one or more processing techniques. In an exemplary embodiment of the present invention, the one or more processing technique is a geospatial intelligence technique. The damage computation engine 114 creates a map view of the one or more impacted areas based on a severity of impact and displays the map view via the visual interface 112.

The damage computation engine 114 determines the boundary vertices of the one or more impacted areas in the order of severity of impact based on the determined area codes using one or more deep learning techniques. Further, the damage computation engine 114 is configured to retrieve insurance data associated with one or more predetermined properties in one or more impacted areas, from the insurance database 104. As already described above, the insurance data may include, but is not limited to property information, coverage details and building attributes. Examples of property information may include, but are not limited to construction time, residence type, occupancy, nearby emergency services. In an embodiment of the present invention, building attributes may include, but are not limited to address, area information, number of rooms, material characteristics and number of floors.

The damage computation engine 114 generates a second group of datasets associated with one or more impacted areas, respectively, by processing the determined boundary vertices associated with one or more impacted areas and retrieved insurance data associated with one or more predetermined properties. In an exemplary embodiment of the present invention, the damage computation engine 114 maps the insurance data associated with one or more properties in each of the impacted areas with the boundary vertices of the corresponding impacted area using geospatial intelligence techniques.

The damage computation engine 114, retrieves images associated with one or more impacted areas based on the corresponding dataset from the first group of datasets second group of datasets from the one or more image servers 106. The damage computation engine 114 is configured to analyze the retrieved images based on set of parameters such as clarity, image format, ground sampling distance, cloud cover, image latency etc. and determine if the image is suitable for further processing.

The damage computation engine 114 rejects the images, if the retrieved images do not meet predefined thresholds (as described in paragraphs 28-33) associated with the set of parameters. Further, new images are retrieved until the images meet the predefined thresholds. The damage computation engine 114 further processes the retrieved images using one or more image processing techniques, if the retrieved images meet the predefined thresholds associated with the set of parameters. In an embodiment of the present invention the image processing techniques is pixel wise segmentation technique. In an exemplary embodiment of the present invention, each satellite image is processed to generate a corresponding image tile by using image processing techniques such as image ingestion, cloud masking, pan sharpening and tilt splitting.

The damage computation engine 114 extracts geo-coordinates of the predetermined one or more properties from the processed images associated with corresponding one or more potential areas using one or more address standardization techniques and geocoding techniques. Further, the damage computation engine 114 identifies a boundary associated with each of the predetermined properties based on the extracted geo-coordinates using one or more image processing techniques. The damage computation 114 maps the boundary associated with each of the properties with the insurance data embedded in the corresponding second group of datasets to create one or more property views. Each property view is representative of a predetermined property in the corresponding potential area. In an embodiment of the present invention, the one or more property views are created from one or more images using one or more image processing techniques such as image stitching. In an exemplary embodiment of the present invention, an image processing framework such as open CV is used for image stitching. In an embodiment of the present invention, each property view includes boundary vertices of the corresponding property, one or more images of the corresponding property, insurance data (as described in para 18) associated with corresponding property, other properties surrounding the corresponding property etc.

The damage computation engine 114, further computes damages associated with each of the predetermined one or more properties based on a comparison between the pre-calamity data and post-calamity data or based on the post-calamity data or both. In an embodiment of the present invention, the damage computation engine 114 performs a check to determine if the pre-calamity data is available. If it is determined that the pre-calamity data is available, the damage computation engine 114 compares the post-calamity data with the pre-calamity data using a third set of rules to compute damages associated with each of the predetermined properties. In exemplary embodiment of the present invention, the third set of rules comprises supplementing post calamity data with pre-calamity data for determining damages to the shingles associated with each property, evaluating total damaged area associated with each property and determining damages to chimney, skylight, flashing, exhaust vents, dormer, antennas or other installations, damage to fascia, gutter, soffit associated with each property.

The damage computation engine 114, further computes damages associated with each of the predetermined one or more properties from the post-calamity data using a fourth set of rules if it is determined that the pre-calamity data is not available. In an exemplary embodiment of the present invention, the fourth set of rules includes reconstructing each of the predetermined properties using contouring technique.

In another embodiment of the present invention, the damage computation engine 114, computes damages associated with each of the predetermined one or more properties based on a comparison between the pre-calamity and post-calamity data (referred to as first set of damages) using the third set of rules (as described in para 44). The damage computation engine 114, further computes damages from the post-calamity data (referred to as second set of damages) using a fourth set of rules. The damage computation engine 114 validates computed second set of damages based on the first set of damages using a fifth set of rules. In an exemplary embodiment of the present invention, the fifth set of rules comprises determining confidence levels for the second set of damages for each of the properties based on a comparison with the first set of damages using building attributes such as complexity of the roof, extent of structural damage and potential of leakage and interior damage.

Furthermore, the damage computation engine 114 determines a repair cost associated with each of the predetermined properties based on the computed damages using a sixth set of rules. In an exemplary embodiment of the present invention, the sixth set of rules includes determining the repair cost based on different line items, number of units of one or more items, type of material, material cost, item cost, a cost associated with installing or removing an item, labor cost associated with detaching and resetting an item.

Yet further, the damage computation engine 114 is configured to generate a detailed report of the computed damages and associated repair cost. In an exemplary embodiment of the invention the detailed report is displayed via the visual interface 112.

In another embodiment of the present invention, the damage computation subsystem 108 may be implemented in a cloud computing architecture in which data, applications, services, and other resources are stored and delivered through shared data-centers. In an exemplary embodiment of the present invention, the functionalities of the damage computation subsystem 108 are delivered to a tester as software as a service (SAAS).

In another embodiment of the present invention, the damage computation subsystem 108 may be implemented as a client-server architecture, wherein the terminal device 110 accesses a server hosting the subsystem 108 over a communication network (not shown).

In yet another embodiment of the present invention the data computation subsystem 108 may be accessed through a web address via the terminal device 110.

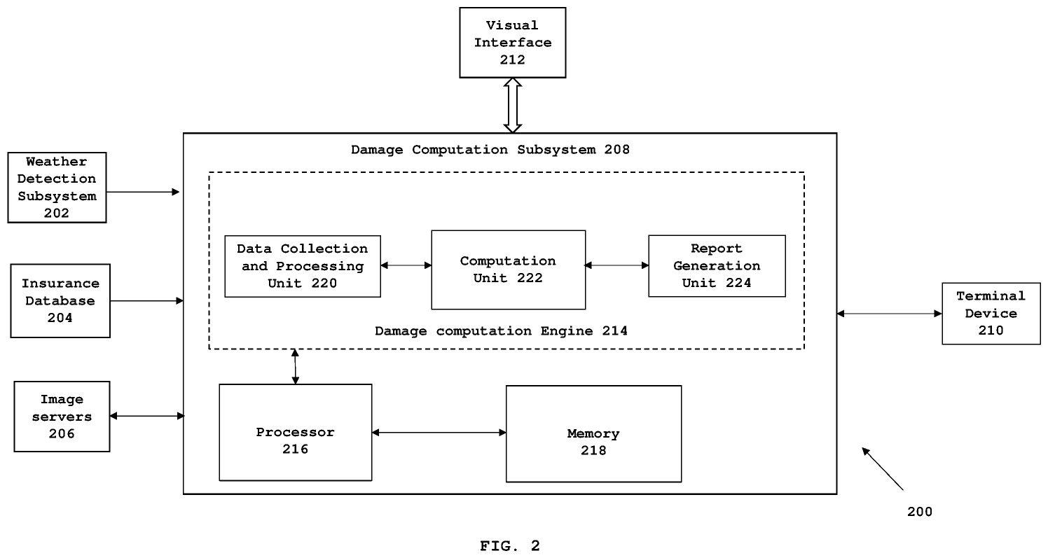

Referring to FIG. 2 a detailed block diagram of a damage computation subsystem for computing infrastructural damages caused by a calamity, in accordance with an embodiment of the present invention is illustrated. The damage computation subsystem 208 interfaces with the weather detection subsystem 202, the insurance database 204, and the one or more image servers 206 over a first communication channel (not shown). Further, the damage computation subsystem 208 interfaces with the terminal device 210 over a second communication channel (not shown). The damage computation subsystem 202 monitors weather and calamity prediction data, classifies one or more geographical areas to be impacted by one or more predicted calamities based on severity of impact and generates pre-calamity data associated with one or more properties in the one or more geographical areas using one or more processing techniques. Further, the damage computation subsystem 208 generates a post-calamity data and computes damages associated with one or more properties.

The damage computation subsystem 208 comprises a visual interface 212, a damage computation engine 214, a processor 216 and a memory 218. In various embodiments of the present invention, the damage computation subsystem 208 has multiple units which work in conjunction with each other for computing infrastructural damages caused by the calamity. The various units of the damage computation engine 214 are operated via the processor 216 specifically programmed to execute instructions stored in the memory 218 for executing respective functionalities of the units of the subsystem 208 in accordance with various embodiments of the present invention.

In an exemplary embodiment of the present invention, the visual interface 212 is configured with graphical icons to select one or more properties and their associated data, and view one or more processing and computation results generated by the damage computation engine 214.

In an embodiment of the present invention, the damage computation engine 214 comprises a data collection and processing unit 220, a computation unit 222, and a report generation unit 224.

In various embodiments of the present invention, the data collection and processing unit 220 is configured to retrieve data from the weather detection subsystem 202, insurance database 204 and the one or more image servers 206, and process the retrieved data to generate the pre-calamity data the and post calamity data. In particular, the data collection and processing unit 220 is configured to monitor weather conditions and calamity predictions via the weather detection subsystem 202. The data collection and processing unit 220 retrieves weather and calamity prediction data associated with one or more geographical areas. The data collection and processing unit 220 identifies one or more geographical areas to be impacted during a predicted calamity based on the weather and calamity prediction data retrieved from the weather detection subsystem 202 using one or more processing techniques. The geographical areas which may be impacted by the predicted calamity are hereinafter referred to as potential areas. The data collection and processing unit 220 further determines area codes associated with corresponding one or more potential areas using the one or more processing techniques. In an exemplary embodiment of the present invention, the one or more processing techniques may be a geospatial intelligence technique. Further, the data collection and processing unit 220 classifies the one or more potential areas based on severity of impact in said areas using one or more risk classification techniques. The data collection and processing unit 220 creates a map view of the one or more potential areas based on the severity of predicted impact and displays the map view via the visual interface 212. The data collection and processing unit 220, thereafter evaluates the date and time for initiating the generation of the pre-calamity data based on the retrieved calamity prediction and severity of impact.

In an embodiment of the present invention, the data collection and processing unit 220 determines the boundary vertices of the one or more potential areas in the order of severity of impact based on the determined area codes using one or more deep learning techniques. Further, the data collection and processing unit 220 is configured to retrieve insurance data associated with one or more properties in one or more potential areas, respectively from the insurance database 204. As already described above, the insurance data may include, but is not limited to property information, coverage details and building attributes. Examples of property information may include, but are not limited to construction time, residence type, occupancy, nearby emergency services. In an embodiment of the present invention, building attributes may include, but are not limited to address, area information, number of rooms, material characteristics and number of floors. In an embodiment of the present invention, the data collection and processing unit 220 may initiate retrieval of insurance data based on a selection of one or more properties in the said one or more areas. The one or more properties may be predetermined via the visual interface 212.

In an embodiment of the present invention, the data collection and processing unit 220 generates a first group of datasets associated with one or more potential areas, respectively, by processing the evaluated date and time, the determined boundary vertices and the retrieved insurance data using a first set of rules. In an exemplary embodiment of the present invention, the first set of rules comprises mapping the insurance data associated with one or more properties in each of the potential areas with the boundary vertices of the corresponding potential area using geospatial intelligence techniques. Further, the first set of rules comprises combining the mapped data with date and time for initiating the generation of the pre-calamity data.

The data collection and processing unit 220 generates a pre-calamity data associated with one or more potential areas based on the generated dataset using one or more processing techniques. The pre-calamity data includes a property view of each of the predetermined properties, one or more attributes associated with each of the predetermined properties and damage risk associated with each of the said properties. In particular, the data collection and processing unit 220, retrieves images associated with one or more potential areas based on a corresponding dataset from the first group of datasets from the one or more image servers 106. The data collection and processing unit 220 is configured to analyze the retrieved images based on set of parameters such as clarity, image format, ground sampling distance, cloud cover, image latency etc. and determines if the image is suitable for further processing.

The data collection and processing unit 220 rejects the images, if the retrieved images do not meet predefined thresholds associated with the set of parameters. In an exemplary embodiment of the present invention, the predefined thresholds associated with the set of parameters are listed below:

For clarity: Image resolution should be 80 cm by 30 cm for high level assessment of damaged area and greater than 10 cm to quantify the extent of damages;

Image format: Ortho-rectified Geotiff images and metadata files in JSON format;

Ground Sampling Distance (GSD): GSD for satellite images must be 0.3 to 0.8 m for panchromatic, 1-2 m for multispectral; for aircraft imagery GSD should be less than 0.1 m;

Cloud Cover : Cloud cover should be less than 20% for satellite imagery and less than 10% for aircraft imagery;

Image latency: image latency should be less than 48 hours.

Further, new images are retrieved until the images meet the predefined thresholds. The data collection and processing unit 220 further processes the retrieved images using one or more image processing techniques if the retrieved images meet the predefined thresholds associated with the set of parameters. In an embodiment of the present invention the image processing technique is pixel wise segmentation technique. In an exemplary embodiment of the present invention, each satellite image is processed to generate a corresponding image tile by using image processing techniques such as image ingestion, cloud masking, pan sharpening and tilt splitting.

The data collection and processing unit 220 extracts geo-coordinates of the predetermined one or more properties from the processed images associated with corresponding one or more potential areas using one or more address standardization techniques and geocoding techniques. Further, the data collection and processing unit 220 identifies a boundary associated with each of the predetermined properties, respectively based on the extracted geo-coordinates using one or more image processing techniques. The data collection and processing unit 220 maps the boundary associated with each of the properties with the insurance data embedded in the corresponding first group of datasets to create one or more property views. Each property view is representative of a predetermined property in the corresponding potential area. In an embodiment of the present invention, the one or more property views are created from one or more images using one or more image processing techniques such as image stitching. In an exemplary embodiment of the present invention, an image processing framework such as open CV is used for image stitching. In an embodiment of the present invention, each property view includes boundary vertices of the corresponding property, one or more images of the corresponding property, insurance data (as described in para 18) associated with corresponding property, other properties surrounding the corresponding property etc.

The data collection and processing unit 220 is configured to determine one or more roof characteristics associated with each of the predetermined properties by analyzing the corresponding property view. The data collection and processing unit 220 analyses each property view using a combination of one or more deep learning and image processing techniques to identify one or more roof characteristics associated with a predetermined property. In an embodiment of the present invention, the one or more roof characteristics may include, but are not limited to roof type, roof pitch, roof area, roof components and shingle characteristics.

Further, the data collection and processing unit 220, is configured to compute a damage risk associated with each of the predetermined properties using a second set of rules. The damage computation engine 114 analyzes one or more property views and associated one or more roof characteristics using the second set of rules. In an exemplary embodiment of the present invention, the second set of rules includes identifying any existing damages or weak construction indicating high loss on occurrence of the predicted calamity by analyzing the property view, more particularly the roof images associated with each of the predetermined properties; determining elements representative of increase in damage exposure, such as trees proximal to the predetermined properties, lack of properties surrounding the predetermined property to reduce wind speed etc., nearby water bodies, by analyzing the surrounding areas of each predetermined property; and analyzing severity of predicted impact in the property location and coverage amount associated with total loss of the property.

In an embodiment of the present invention, the data collection and processing unit 220, generates a post-calamity data based on a second group of datasets. The post-calamity data includes a property view of each of the predetermined properties and one or more attributes associated with each of the predetermined properties. In particular, the data collection and processing unit 220 monitors end of the calamity via the weather detection subsystem 202. The data collection and processing unit 220 retrieves weather and calamity prediction data associated with one or more impacted areas. The data collection and processing unit 220 further determines area codes associated with corresponding one or more impacted areas using the one or more processing techniques. In an exemplary embodiment of the present invention, the one or more processing technique is a geospatial intelligence technique. The data collection and processing unit 220 creates a map view of the one or more impacted areas based on a severity of impact and displays the map view via the visual interface 212.

The data collection and processing unit 220 determines the boundary vertices of the one or more impacted areas in the order of severity of impact based on the determined area codes using one or more deep learning techniques. Further, the data collection and processing unit 220 is configured to retrieve insurance data associated with one or more predetermined properties in one or more impacted areas, from the insurance database 204. As already described above, the insurance data may include, but is not limited to property information, coverage details and building attributes. Examples of property information may include, but are not limited to construction time, residence type, occupancy, nearby emergency services. In an embodiment of the present invention, building attributes may include, but are not limited to address, area information, number of rooms, material characteristics and number of floors.

The data collection and processing unit 220 generates a second group of datasets associated with one or more impacted areas, respectively, by processing the determined boundary vertices associated with one or more impacted areas and retrieved insurance data associated with one or more predetermined properties. In an exemplary embodiment of the present invention, data collection and processing unit 220 maps the insurance data associated with one or more properties in each of the impacted areas with the boundary vertices of the corresponding impacted area using geospatial intelligence techniques.

The data collection and processing unit 220, retrieves images associated with one or more impacted areas based on the corresponding dataset from the first group of datasets second group of datasets from the one or more image servers 106. The data collection and processing unit 220 is configured to analyze the retrieved images based on set of parameters such as clarity, image format, ground sampling distance, cloud cover, image latency etc. and determine if the image is suitable for further processing.

The data collection and processing unit 220 rejects the images, if the retrieved images do not meet predefined thresholds (as described in paragraphs 28-33) associated with the set of parameters. Further, new images are retrieved until the images meet the predefined thresholds. The data collection and processing unit 220 further processes the retrieved images using one or more image processing techniques, if the retrieved images meet the predefined thresholds associated with the set of parameters. In an embodiment of the present invention, the image processing technique is pixel wise segmentation technique. In an exemplary embodiment of the present invention, each satellite image is processed to generate a corresponding image tile by using image processing techniques such as image ingestion, cloud masking, pan sharpening and tilt splitting.

The data collection and processing unit 220 extracts geo-coordinates of the predetermined one or more properties from the processed images associated with corresponding one or more potential areas using one or more address standardization techniques and geocoding techniques. Further, the data collection and processing unit 220 identifies a boundary associated with each of the predetermined properties based on the extracted geo-coordinates using one or more image processing techniques. data collection and processing unit 220 maps the boundary associated with each of the properties with the insurance data embedded in the corresponding second group of datasets to create one or more property views. Each property view is representative of a predetermined property in the corresponding potential area. In an embodiment of the present invention, the one or more property views are created from one or more images using one or more image processing techniques such as image stitching. In an exemplary embodiment of the present invention, an image processing framework such as open CV is used for image stitching. In an embodiment of the present invention, each property view includes boundary vertices of the corresponding property, one or more images of the corresponding property, insurance data (as described in para 18) associated with corresponding property, other properties surrounding the corresponding property etc.

In various embodiments of the present invention, the computation unit 222 is configured to compute damages associated with each of the predetermined properties. In particular, the computation unit 222 receives the pre-calamity data and the post calamity data from the data collection and processing unit 220. The computation unit 222, further computes damages associated with each of the predetermined one or more properties based on a comparison between the pre-calamity data and post-calamity data or based on the post-calamity data or both. In an embodiment of the present invention, computation unit 222 performs a check to determine if the pre-calamity data is available. If it is determined that the pre-calamity data is available, the damage computation unit 222 compares the post-calamity data with the pre-calamity data using a third set of rules to compute damages associated with each of the predetermined properties. In exemplary embodiment of the present invention, the third set of rules comprises supplementing post calamity data with pre-calamity data for determining damages to the shingles associated with each property, evaluating total damaged area associated with each property and determining damages to chimney, skylight, flashing, exhaust vents, dormer, antennas/other installations, damage to fascia, gutter, soffit associated with each property.

The computation unit 222, further computes damages from the post-calamity data using a fourth set of rules if it is determined that the pre-calamity data is not available. In an exemplary embodiment of the present invention, the fourth set of rules includes reconstructing each of the predetermined properties using contouring techniques.

In another embodiment of the present invention, the computation unit 222, is configured to compute damages associated with each of the predetermined one or more properties based on a comparison between the pre-calamity and post-calamity data(referred to as a first set of damages)using the third set of rules(as described in para 44). The computation unit 222, further computes damages from the post-calamity data (referred to as second set of damages) using a fourth set of rules. The damage computation unit 222 validates computed second set of damages based on the first set of damages using a fifth set of rules. In an exemplary embodiment of the present invention, the fifth set of rules comprises determining confidence levels for the second set of damages for each of the properties based on a comparison with the first set of damages using building attributes such as complexity of the roof, extent of structural damage and potential of leakage and interior damage.

Furthermore, the computation unit 222 determines a repair cost associated with each of the predetermined properties based on the computed damages using a sixth set of rules. In an exemplary embodiment of the present invention, the sixth set of rules includes determining the repair cost based on different line items, number of units of one or more items, type of material, material cost, item cost, a cost associated with installing or removing an item, labor cost associated with detaching and resetting an item.

The report generation unit 224 is configured to receive the computed damages and repair cost determined by the computing unit 222. The report generation unit 224 is configured to generate a detailed report of the computed damages and associated repair cost. In an exemplary embodiment of the invention the detailed report is displayed via the visual interface 212.

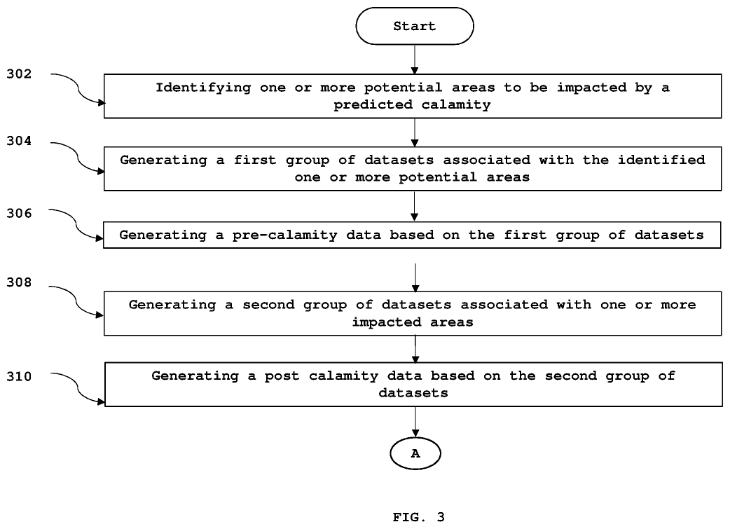

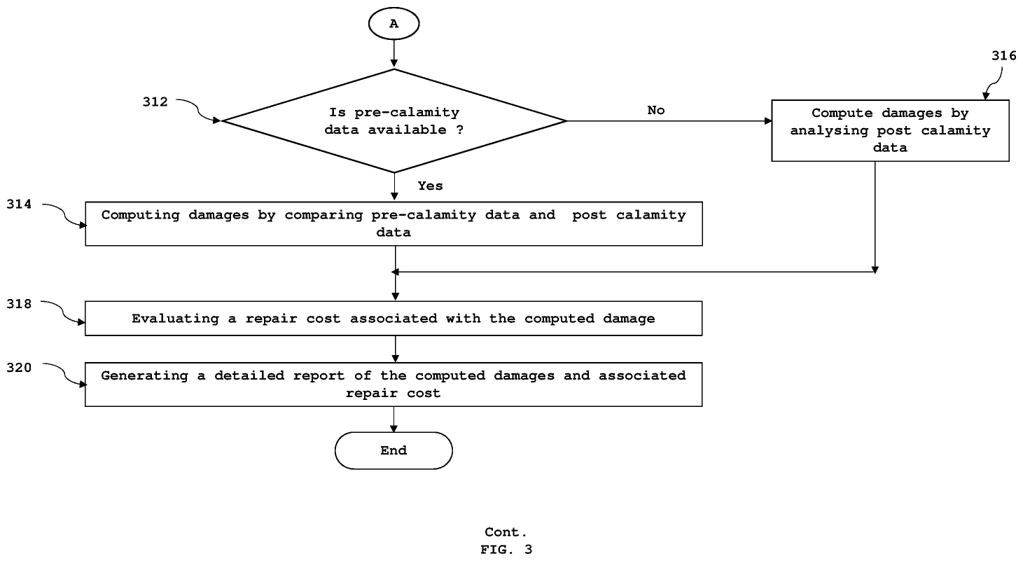

FIG. 3 is a flowchart illustrating a method for computing infrastructural damages caused by a calamity, in accordance with an embodiment of the present invention.

At step 302, one or more potential areas to be impacted by a predicted calamity are identified. In an embodiment of the present invention, weather conditions and calamity predictions are monitored via a weather detection subsystem. Weather and calamity prediction data associated with one or more geographical areas are retrieved. One or more geographical areas to be impacted during a predicted calamity are identified based on the weather and calamity prediction data retrieved from the weather subsystem using one or more processing techniques. The geographical areas which may be impacted by the predicted calamity are hereinafter referred to as potential areas. The area codes associated with corresponding one or more potential areas are determined using the one or more processing techniques. In an exemplary embodiment of the present invention, the one or more processing technique is a geospatial intelligence technique. Further, the one or more potential areas are classified based on severity of impact in said areas using one or more risk classification techniques. A map view of the one or more potential areas is created based on the severity of predicted impact. The date and time for initiating the generation of the pre-calamity data is evaluated based on the retrieved calamity prediction and severity of impact.

At step 304, a first group of datasets associated with the identified one or more potential areas is generated. In an embodiment of the present invention, the boundary vertices of the one or more potential areas are determined in the order of severity of impact based on the determined area codes using one or more deep learning techniques. Further, insurance data associated with one or more properties in one or more potential areas, respectively is retrieved from the insurance database. As already described above, the insurance data may include, but is not limited to property information, coverage details and building attributes. Examples of property information may include, but are not limited to construction time, residence type, occupancy, nearby emergency services. In an embodiment of the present invention, building attributes may include, but are not limited to address, area information, number of rooms, material characteristics and number of floors. In an embodiment of the present invention, retrieval of insurance data based on a selection of one or more properties in the said one or more areas may be initiated. The one or more properties may be predetermined via the visual interface.

The first group of datasets associated with one or more potential areas, respectively, is generated by processing the evaluated date and time, the determined boundary vertices and the retrieved insurance data using a first set of rules. In an exemplary embodiment of the present invention, the first set of rules comprises mapping the insurance data associated with one or more properties in each of the potential areas with the boundary vertices of the corresponding potential area using geospatial intelligence techniques. Further, the first set of rules comprises combining the mapped data with date and time for initiating the generation of the pre-calamity data.

At step 306, a pre-calamity data is generated based on the first group of datasets. In an embodiment of the present invention, a pre-calamity data associated with one or more potential areas is generated based on the corresponding dataset from first group of datasets using one or more processing techniques. The pre-calamity data includes a property view of each of the predetermined properties, one or more attributes associated with each of the predetermined properties and damage risk associated with each of the said properties. In particular, images associated with one or more potential areas are retrieved based on the corresponding dataset from the first group of datasets from the one or more image servers. The retrieved images are analyzed based on a set of parameters such as clarity, image format, ground sampling distance, cloud cover, image latency etc. and determine if the image is suitable for further processing.

The retrieved images are rejected if they do not meet predefined thresholds associated with the set of parameters. In an exemplary embodiment of the present invention, the predefined thresholds associated with the set of parameters are as follows, clarity: Image resolution should be 80 cm by 30 cm for high level assessment of damaged area and greater than 10 cm to quantify the extent of damages; image format: ortho-rectified Geotiff images and metadata files in JSON format; round Sampling Distance (GSD): GSD for satellite images must be 0.3 to 0.8 m for panchromatic, 1-2 m for multispectral; for aircraft imagery GSD should be less than 0.1 m; Cloud Cover : Cloud cover should be less than 20% for satellite imagery and less than 10% for aircraft imagery; Image latency: image latency should be less than 48 hours. Further, new images are retrieved until the images meet the predefined thresholds. The retrieved images are processed using one or more image processing techniques, if the retrieved images meet the predefined thresholds associated with the set of parameters. In an embodiment of the present invention, the image processing technique is pixel wise segmentation technique. In an exemplary embodiment of the present invention, each satellite image is processed to generate a corresponding image tile by using image processing techniques such as image ingestion, cloud masking, pan sharpening and tilt splitting.

The geo-coordinates of the predetermined one or more properties are extracted from the processed images associated with corresponding one or more potential areas using one or more address standardization techniques and geocoding techniques. Further, a boundary associated with each of the predetermined properties is identified, respectively based on the extracted geo-coordinates using one or more image processing techniques. The boundary associated with each of the properties is mapped with the insurance data embedded in the corresponding first group of datasets to create one or more property views. Each property view is representative of a predetermined property in the corresponding potential area. In an embodiment of the present invention, the one or more property views are created from one or more images using one or more image processing techniques such as image stitching. In an exemplary embodiment of the present invention, an image processing framework such as open CV is used for image stitching. In an embodiment of the present invention, each property view includes boundary vertices of the corresponding property, one or more images of the corresponding property, insurance data (as described in para 18) associated with corresponding property, other properties surrounding the corresponding property etc.

One or more roof characteristics associated with each of the predetermined properties are determined by analyzing the corresponding property view. Each property view is analyzed using a combination of one or more deep learning and image processing techniques to identify one or more roof characteristics associated with each predetermined property. In an embodiment of the present invention, the one or more roof characteristics may include, may include, but are not limited to roof type, roof pitch, roof area, roof components and shingle characteristics.

Further, a damage risk associated with each of the predetermined properties is computed using a second set of rules. One or more property views and associated one or more roof characteristics are analyzed using the second set of rules. In an exemplary embodiment of the present invention, the second set of rules includes identifying any existing damages or weak construction indicating high loss on occurrence of the predicted calamity by analyzing the property view, more particularly the roof images associated with each of the predetermined properties; determining elements representative of increase in damage exposure, such as trees proximal to the predetermined properties, lack of properties surrounding the predetermined property to reduce wind speed etc., nearby water bodies, by analyzing the surrounding areas of each predetermined property; and analyzing severity of predicted impact in the property location and coverage amount associated with total loss of the property.

At step 308, a second group of datasets associated with one or more impacted areas are generated. In particular, end of the calamity is monitored via the weather detection subsystem. The weather and calamity prediction data associated with one or more impacted areas is retrieved. The one or more impacted areas are representative of one or more geographical areas impacted by the predicted calamity. Further, area codes are determined associated with corresponding one or more impacted areas using the one or more processing techniques. In an exemplary embodiment of the present invention, the one or more processing technique is a geospatial intelligence technique. A map view of the one or more impacted areas is created based on a severity of impact.

The boundary vertices of the one or more impacted areas are determined in the order of severity of impact based on the determined area codes using one or more deep learning techniques. Further, the insurance data associated with one or more predetermined properties in one or more impacted areas, respectively, is retrieved from the insurance database. As already described above, the insurance data may include, but is not limited to property information, coverage details and building attributes. Examples of property information may include, but are not limited to construction time, residence type, occupancy, nearby emergency services. In an embodiment of the present invention, building attributes may include, but are not limited to address, area information, number of rooms, material characteristics and number of floors.

The second group of datasets associated with one or more impacted areas, respectively, are generated by processing the determined boundary vertices associated with one or more impacted areas and retrieved insurance data associated with one or more predetermined properties. In an exemplary embodiment of the present invention, the insurance data associated with one or more properties in each impacted area is mapped with the boundary vertices of the corresponding impacted area using geospatial intelligence techniques.

At step 310, a post calamity data is generated based on second group of datasets. In an embodiment of the present invention, a post-calamity data associated with one or more impacted areas is generated based on a second group of datasets. The post-calamity data includes a property view of each of the predetermined properties and one or more attributes associated with each of the predetermined properties. Further, images associated with one or more impacted areas are retrieved based on a corresponding dataset from the second group of datasets from the one or more image servers 106. The retrieved images are analyzed based on set of parameters such as clarity, image format, ground sampling distance, cloud cover, image latency etc. and determine if the image is suitable for further processing.

The images are rejected, if the retrieved images do not meet predefined thresholds associated with the set of parameters. In an exemplary embodiment of the present invention, the predefined thresholds associated with the set of parameters are as follows, clarity: Image resolution should be 80 cm by 30 cm for high level assessment of damaged area and greater than 10 cm to quantify the extent of damages; image format: ortho-rectified Geotiff images and metadata files in JSON format; round Sampling Distance (GSD): GSD for satellite images must be 0.3 to 0.8 m for panchromatic, 1-2 m for multispectral; for aircraft imagery GSD should be less than 0.1 m; Cloud Cover: Cloud cover should be less than 20% for satellite imagery and less than 10% for aircraft imagery; Image latency: image latency should be less than 48 hours. Further, new images are retrieved until the images meet the predefined thresholds. The retrieved images are processed using one or more image processing techniques, if the retrieved images meet the predefined thresholds associated with the set of parameters. In an embodiment of the present invention the image processing technique is pixel wise segmentation technique. In an exemplary embodiment of the present invention, each satellite image is processed to generate a corresponding image tile by using image processing techniques such as image ingestion, cloud masking, pan sharpening and tilt splitting.

The geo-coordinates of the predetermined one or more properties are extracted from the processed images associated with corresponding one or more potential areas using one or more address standardization techniques and geocoding techniques. Further, a boundary associated with each of the predetermined properties is identified, respectively based on the extracted geo-coordinates using one or more image processing techniques. The boundary associated with each of the properties is mapped with the insurance data embedded in the corresponding second group of datasets to create one or more property views. Each property view is representative of a predetermined property in the corresponding potential area. In an embodiment of the present invention, the one or more property views are created from one or more images using one or more image processing techniques such as image stitching. In an exemplary embodiment of the present invention, an image processing framework such as open CV is used for image stitching. In an embodiment of the present invention, each property view includes boundary vertices of the corresponding property, one or more images of the corresponding property, insurance data (as described in para 18) associated with corresponding property, other properties surrounding the corresponding property etc.

At step 312, a check is performed to determine if the pre-calamity data is available for damage computation. At step 314, damages are computed by comparing pre-calamity data and post calamity data. In particular, the post-calamity data is compared with the pre-calamity data using a third set of rules to compute damages associated with each of the predetermined properties. In exemplary embodiment of the present invention, the third set of rules comprises determining damages to the shingles associated with each property, evaluating total damaged area associated with each property and determining damages to chimney, skylight, flashing, exhaust vents, dormer, antennas/other installations, damage to fascia, gutter, soffit associated with each property.

At step 316, damages are computed by analyzing post calamity data. In particular, damages are computed using a fourth set of rules if it is determined that the pre-calamity data is not available. In an exemplary embodiment of the present invention, the fourth set of rules includes reconstructing each of the predetermined properties using contouring techniques.

At step 318, a repair cost associated with the computed damage is evaluated. In particular, the repair cost associated with each of the predetermined properties is evaluated based on the computed damages using a sixth set of rules. In an exemplary embodiment of the present invention, the sixth set of rules includes determining the repair cost based on different line items, number of units of one or more items, type of material, material cost, item cost, a cost associated with installing or removing an item, labor cost associated with detaching and resetting an item. At step 320, a detailed report of the computed damages and associated repair cost is generated.

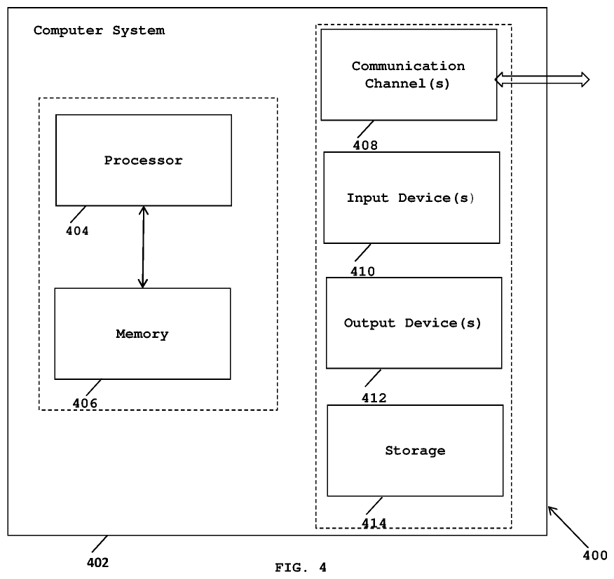

FIG. 4 illustrates an exemplary computer system in which various embodiments of the present invention may be implemented. The computer system 402 comprises a processor 404 and a memory 406. The processor 404 executes program instructions and is a real processor. The computer system 402 is not intended to suggest any limitation as to scope of use or functionality of described embodiments. For example, the computer system 402 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 406 may store software for implementing various embodiments of the present invention. The computer system 402 may have additional components. For example, the computer system 402 includes one or more communication channels 408, one or more input devices 410, one or more output devices 412, and storage 414. An interconnection mechanism (not shown) such as a bus, controller, or network, interconnects the components of the computer system 402. In various embodiments of the present invention, operating system software (not shown) provides an operating environment for various softwares executing in the computer system 402, and manages different functionalities of the components of the computer system 402.

The communication channel(s) 408 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 410 may include, but not limited to, a keyboard, mouse, pen, joystick, trackball, a voice device, a scanning device, touch screen or any another device that is capable of providing input to the computer system 402. In an embodiment of the present invention, the input device(s) 410 may be a sound card or similar device that accepts audio input in analog or digital form. The output device(s) 412 may include, but not limited to, a user interface on CRT or LCD, printer, speaker, CD/DVD writer, or any other device that provides output from the computer system 402.

The storage 414 may include, but not limited to, magnetic disks, magnetic tapes, CD-ROMs, CD-RWs, DVDs, flash drives or any other medium which can be used to store information and can be accessed by the computer system 402. In various embodiments of the present invention, the storage 414 contains program instructions for implementing the described embodiments.

The present invention may suitably be embodied as a computer program product for use with the computer system 402. The method described herein is typically implemented as a computer program product, comprising a set of program instructions which is executed by the computer system 402 or any other similar device. The set of program instructions may be a series of computer readable codes stored on a tangible medium, such as a computer readable storage medium (storage 414), for example, diskette, CD-ROM, ROM, flash drives or hard disk, or transmittable to the computer system 402, via a modem or other interface device, over either a tangible medium, including but not limited to optical or analogue communications channel(s) 408. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A method for computing infrastructural damages caused by a calamity, wherein the method is implemented by at least one processor executing program instructions stored in a memory, the method comprising:
generating, by the processor, a first group of datasets associated with one or more potential areas, wherein the one or more potential areas are representative of one or more geographical areas identified to be impacted by a predicted calamity;
generating, by the processor, a pre-calamity data based on the first group of datasets;
generating, by the processor, a second group of datasets associated with one or more impacted areas, wherein the one or more impacted areas are representative of one or more geographical areas impacted by the predicted calamity;
generating, by the processor, a post calamity data based on the second group of datasets; and
computing, by the processor, damages associated with one or more predetermined properties in each of the one or more impacted areas based on at least one of: the post calamity data, and a comparison between the pre-calamity data and the post calamity data.

2. The method as claimed in claim 1, wherein generating the first group of datasets comprises:
determining boundary vertices associated with each of the one or more potential areas in an order of severity of impact of the predicted calamity, based on area codes corresponding to the one or more potential areas using one or more deep learning techniques; wherein the order of severity of impact is determined using one or more risk classification techniques on a retrieved weather and calamity prediction data associated with one or more potential areas;
evaluating a date and time for initiating generation of the pre-calamity data based on the retrieved weather and calamity prediction data and severity of impact;
processing the determined boundary vertices, the evaluated date and time, and an insurance data using a first set of rules, wherein the first set of rules comprises mapping the insurance data associated with the one or more properties predetermined in each of the potential areas with the boundary vertices of the corresponding potential area using geospatial intelligence techniques; and combining mapped data with the evaluated date and time.

3. The method as claimed in claim 2, wherein the first group of datasets includes boundary vertices associated with the one or more potential areas, the insurance data associated with the one or more predetermined properties and the date and time for initiating generation of the pre-calamity data.

4. The method as claimed in claim 2, wherein determining the area codes associated with the one or more potential areas include identifying the one or more potential areas using one or more processing techniques based on the retrieved weather and calamity prediction data.

5. The method as claimed in claim 2, wherein the insurance data includes property information, coverage details and building attributes associated with the one or more predetermined properties, wherein further the property information includes construction time, residence type, occupancy, nearby emergency services associated with the corresponding predetermined property.

6. The method as claimed in claim 5, wherein the building attributes includes address, area information, number of rooms, material characteristics and number of floors associated with the corresponding predetermined property.

7. The method as claimed in claim 1, wherein the pre-calamity data associated with the one or more potential areas is generated based on a corresponding dataset from the first group of datasets using one or more processing techniques, wherein the one or more processing techniques are selected from at least one of image processing techniques, one or more address standardization techniques and geocoding techniques, further wherein the pre-calamity data includes a property view of each of the one or more predetermined properties, one or more attributes associated with each of the one or more predetermined properties and damage risk associated with each of the one or more predetermined properties.

8. The method as claimed in claim 1, wherein generating the pre-calamity data comprises:
analyzing one or more images associated with the one or more potential areas retrieved from one or more image servers, based on a set of parameters to determine if the images are suitable for processing, wherein the set of parameters includes clarity, image format, ground sampling distance, cloud cover and image latency;
retrieving one or more images associated with the one or more potential areas until the one or more images fulfil a set of predefined thresholds associated with the set of parameters;
generating one or more image tiles corresponding to the retrieved one or more images by processing the retrieved one or more images using one or more image processing techniques;
identifying boundaries corresponding to each of the one or more predetermined properties based on one or more geo-coordinates associated with the one or more predetermined properties extracted from the one or more image tiles associated with corresponding one or more potential areas, using one or more image processing techniques;
creating one or more property views from the one or more processed image tiles using one or more image processing techniques such as image stitching and grabcut, and mapping the boundaries associated with each of the one or more predetermined properties with corresponding insurance data embedded in the corresponding first group of datasets;
determining one or more roof characteristics associated with each of the one or more predetermined properties by analyzing the corresponding property view using a combination of one or more deep learning and image processing techniques; and
computing a damage risk associated with each of the one or more predetermined properties by analysing the corresponding property views and associated one or more roof characteristics using the second set of rules.

9. The method as claimed in claim 8, wherein images associated with the one or more potential areas are retrieved from the one or more image servers based on the corresponding datasets from the first group of datasets.

10. The method as claimed in claim 8, wherein the set of predefined thresholds associated with the set of parameters include, an image resolution of 80 cm by 30 cm for high level assessment of damaged area and greater than 10 cm to quantify extent of damages, for assessing clarity; ortho-rectified Geotiff images and metadata files in JSON format for assessing image format; Ground Sampling Distance (GSD) for satellite images in the range 0.3 to 0.8 m for panchromatic, 1-2 m for multispectral, and Ground Sampling Distance (GSD) less than 0.1 m for aircraft imagery; Cloud Cover less than 20% for satellite imagery and less than 10% for aircraft imagery; and image latency less than 48 hours.

11. The method as claimed in claim 8, wherein the second set of rules include:
identifying any existing damages or weak construction indicating high loss on occurrence of the predicted calamity by analyzing the property view associated with each of the one or more predetermined properties;
determining elements representative of increased damage exposure, such as trees proximal to the predetermined properties, lack of properties surrounding the corresponding predetermined property and nearby water bodies, by analyzing the surrounding areas of each of the one or more predetermined properties; and
analyzing severity of predicted impact in the property location and coverage amount associated with total loss of the property.

12. The method as claimed in claim 1, wherein generating the second group of datasets comprises:
determining area codes associated with the one or more impacted areas by identifying the one or more impacted areas using one or more processing techniques based on a weather and calamity prediction data associated with the one or more impacted areas;
determining boundary vertices of the one or more impacted areas in an order of severity of impact of the predicted calamity, based on area codes corresponding to the one or more impacted areas using one or more deep learning techniques; and
processing the determined boundary vertices and the insurance data associated with the one or more predetermined properties, wherein the insurance data associated with the one or more predetermined properties in each of the impacted areas is mapped with the boundary vertices of the corresponding impacted areas using geospatial intelligence techniques.

13. The method as claimed in claim 12, wherein the second group of datasets include boundary vertices associated with the one or more impacted areas and the insurance data associated with one or more predetermined properties.

14. The method as claimed in claim 1, wherein the post calamity data associated with the one or more potential areas is generated based on a corresponding datasets from the second group of datasets using one or more processing techniques, wherein the one or more processing techniques are selected from at least one of image processing techniques, one or more address standardization techniques and geocoding techniques, further wherein the post-calamity data includes a property view of each of the one or more predetermined properties and one or more attributes associated with each of the one or more predetermined properties.

15. The method as claimed in claim 1, wherein generating the post-calamity data comprises:
analyzing one or more images associated with the one or more impacted areas retrieved from one or more image servers, based on a set of parameters to determine if the images are suitable for processing;
retrieving one or more images associated with the one or more impacted areas until the one or more images fulfil a set of predefined thresholds associated with the set of parameters;
generating one or more image tiles corresponding to the retrieved one or more images by processing said retrieved images using one or more image processing techniques;
identifying boundaries corresponding to each of the predetermined properties based on one or more geo-coordinates associated with the predetermined one or more properties extracted from the one or more image tiles associated with corresponding one or more impacted areas, using one or more image processing techniques; and
creating one or more property views from the one or more images tiles associated with the one or more impacted areas using one or more image processing techniques such as image stitching and grabcut, and mapping the boundaries associated with each of the predetermined properties with the corresponding insurance data embedded in the corresponding second group of datasets.

16. The method as claimed in claim 15, wherein the one or more images associated with the one or more impacted areas are retrieved from the one or more image servers based on a corresponding dataset from the second group of datasets.

17. The method as claimed in claim 15, wherein each property view includes boundary vertices, one or more images, and insurance data associated with the corresponding predetermined property, and other properties surrounding the corresponding predetermined property.

18. The method as claimed in claim 1, wherein computing damages associated with the one or more predetermined properties in each of the one or more impacted areas comprises comparing the pre-calamity data and the post calamity data using a third set of rules, wherein the third set of rules comprises determining damages to shingles associated with each predetermined property, evaluating total damaged area associated with each predetermined property and determining damages to chimney, skylight, flashing, exhaust vents, dormer, antennas or other installations, damages to fascia, gutter and soffit associated with each predetermined property.

19. The method as claimed in claim 1, wherein computing damages associated with one or more predetermined properties in each of the one or more impacted areas comprises analyzing post calamity data using a fourth set of rules, wherein the fourth set of rules includes reconstructing each of the predetermined properties using contouring techniques.

20. A system for computing infrastructural damages caused by a calamity, wherein the system interfaces with a weather subsystem, an insurance database and one or more image servers, the system comprising:
a memory storing program instructions; a processor configured to execute program instructions stored in the memory; and a damage computation engine in communication with the processor and configured to:
generate a first group of datasets associated with one or more potential areas, wherein the one or more potential areas are representative of one or more geographical areas identified to be impacted by a predicted calamity;
generate a pre-calamity data based on the first group of datasets;
generate a second group of datasets associated with one or more impacted areas, wherein the one or more impacted areas are representative of one or more geographical areas impacted by the predicted calamity;
generate a post calamity data based on the second group of datasets; and
compute damages associated with one or more predetermined properties in each of the one or more impacted areas based on at least one of the post calamity data, and a comparison between the pre-calamity data and the post calamity data.

21. The system as claimed in claim 20, wherein the damage computation engine comprises a data collection and processing unit in communication with the processor, said data collection and processing unit is configured to interface with the weather detection subsystem, the insurance database and the one or image servers to retrieve a weather and calamity data associated with the one or more potential areas and the one or more impacted areas, insurance data associated with one or more predetermined properties, and one or more images associated with the one or more potential areas and the one or more impacted areas, respectively.

22. The system as claimed in claim 20, wherein the data collection and processing unit is configured to generate the first group of datasets by:
determining boundary vertices associated with each of the one or more potential areas in an order of severity of impact of the predicted calamity based on area codes corresponding to the one or more potential areas using one or more deep learning techniques;
evaluating a date and time for initiating generation of the pre-calamity data based on the retrieved weather and calamity prediction data and severity of impact;
processing the determined boundary vertices, the evaluated date and time, and the insurance data using a first set of rules, wherein the first set of rules comprises mapping the insurance data associated with predetermined one or more properties in each of the potential areas with the boundary vertices of the corresponding potential area using geospatial intelligence techniques; and combining mapped data with the evaluated date and time.

23. The system as claimed in claim 22, wherein the data collection and processing unit is configured to determine the area codes associated with one or more potential areas by identifying the one or more potential areas using one or more processing techniques based on the retrieved weather and calamity prediction.

24. The system as claimed in claim 22, wherein the data collection and processing unit is configured to generate the pre-calamity data associated with the one or more potential areas based on a corresponding dataset from the first group of datasets using one or more processing techniques, wherein the pre-calamity data includes a property view of each of the one or more predetermined properties, one or more attributes associated with each of the one or more predetermined properties and damage risk associated with each of the one or more predetermined properties.

25. The system as claimed in claim 21, wherein the data collection and processing unit is configured to generate the pre-calamity data by:
analyzing the one or more images associated with the one or more potential areas retrieved from the one or more image servers, based on a set of parameters to determine if the images are suitable for processing; wherein the set of parameters includes clarity, image format, ground sampling distance, cloud cover and image latency;
retrieving one or more images associated with the one or more potential areas until the one or more images fulfil predefined thresholds associated with the set of parameters;
generating one or more image tiles corresponding to retrieved one or more images by processing the retrieved images using one or more image processing techniques;
identifying boundaries corresponding to each of the one or more predetermined properties based on one or more geo-coordinates associated with the one or more predetermined properties extracted from the processed one or more image tiles associated with corresponding one or more potential areas, using one or more image processing techniques;
creating one or more property views from the one or more image tiles using one or more image processing techniques such as image stitching and grabcut, and mapping the boundaries associated with each of the one or more predetermined properties with corresponding insurance data embedded in the corresponding first group of datasets, wherein each of the one or more property views include boundary vertices, one or more images, and insurance data associated with the corresponding property, and other properties surrounding the corresponding predetermined property;
determining one or more roof characteristics associated with each of the one or more predetermined properties by analyzing the corresponding property view using a combination of one or more deep learning and image processing techniques; and
computing a damage risk associated with each of the one or more predetermined properties by analysing one or more property views and associated one or more roof characteristics using a second set of rules.

26. The system as claimed in claim 25, wherein the second set of rules includes:
identifying any existing damages or weak construction indicating high loss on occurrence of the predicted calamity by analyzing the property view associated with each of the one or more predetermined properties;
determining elements representative of increased damage exposure, such as trees proximal to the predetermined properties, lack of properties surrounding the corresponding predetermined property and nearby water bodies, by analyzing the surrounding areas of each of the one or more predetermined properties; and
analyzing severity of predicted impact in the property location and coverage amount associated with total loss of the property.

27. The system as claimed in claim 25, wherein the data collection and processing unit is configured to generate the second group of datasets by:
determining area codes associated with the one or more impacted areas by identifying the one or more impacted areas using one or more processing techniques based on a weather and calamity prediction data associated with the one or more impacted areas;
determining boundary vertices of the one or more impacted areas in an order of severity of impact of the predicted calamity, based on area codes corresponding to one or more impacted areas using one or more deep learning techniques; and
processing the determined boundary vertices and the insurance data associated with the one or more predetermined properties, wherein the insurance data associated with one or more predetermined properties in each of the impacted areas is mapped with the boundary vertices of the corresponding impacted areas using geospatial intelligence techniques.

28. The system as claimed in claim 21, wherein the data collection and processing unit is configured to generate the post calamity data associated with the one or more potential areas based on corresponding datasets from the second group of datasets using one or more processing techniques, wherein the post-calamity data includes a property view of each of the one or more predetermined properties and one or more attributes associated with each of the one or more predetermined properties.

29. The system as claimed in claim 21, wherein the data collection and processing unit is configured to generate the post-calamity data by:
analyzing the one or more images associated with the one or more impacted areas retrieved from the one or more image servers, based on a set of parameters to determine if the images are suitable for processing;
retrieving the one or more images associated with the one or more impacted areas until the one or more images fulfil a set of predefined thresholds associated with the set of parameters;
generating one or more image tiles corresponding to the retrieved one or more images by processing said retrieved images using one or more image processing techniques;
identifying boundaries corresponding to each of the predetermined properties based on one or more geo-coordinates associated with the one or more predetermined properties extracted from the one or more image tiles associated with corresponding one or more impacted areas, using one or more image processing techniques; and
creating one or more property views from one or more image tiles associated with the one or more impacted areas using one or more image processing techniques such as image stitching and grabcut, and mapping the boundaries associated with each of the predetermined properties with the corresponding insurance data embedded in the corresponding second group of datasets, wherein each property view includes boundary vertices, one or more images, and insurance data associated with the corresponding predetermined property, and other properties surrounding the corresponding predetermined property.

30. The system as claimed in claim 20, wherein the damage computation engine comprises a computation unit in communication with the processor, said computation unit is configured to compute damages associated with the one or more predetermined properties in each of the impacted areas by comparing the pre-calamity data and the post calamity data using a third set of rules, wherein the third set of rules comprises determining damages to shingles associated with each predetermined property, evaluating total damaged area associated with each predetermined property and determining damages to chimney, skylight, flashing, exhaust vents, dormer, antennas or other installations, damages to fascia, gutter and soffit associated with each of the one or more predetermined properties.

31. The system as claimed in claim 20, wherein the damage computation engine comprises a computation unit in communication with the processor, said computation unit is configured to compute damages associated with the one or more predetermined properties in each of the one or more impacted areas by analyzing post calamity data using a fourth set of rules, wherein the fourth set of rules includes reconstructing each of the predetermined properties using contouring techniques.

32. A computer program product comprising:
a non-transitory computer-readable medium having computer-readable program code stored thereon, the computer-readable program code comprising instructions that, when executed by a processor, cause the processor to:
generate a first group of datasets associated with one or more potential areas, wherein the one or more potential areas are representative of one or more geographical areas identified to be impacted by a predicted calamity;
generate a pre-calamity data based on the first group of datasets;
generate a second group of datasets associated with one or more impacted areas, wherein the one or more impacted areas are representative of one or more geographical areas impacted by the predicted calamity;
generate a post calamity data based on the second group of datasets; and
compute damages associated with one or more predetermined properties in each of the one or more impacted areas based on at least one of the post calamity data, and a comparison between the pre-calamity data and the post calamity data.
